(19) United States
(12) Patent Application Publication
(10) Pub. No.: US 2020/0031094 A1
(43) Pub. Date: Jan. 30, 2020

(54) THERMALLY EXPANDABLE SHEET AND SHAPED OBJECT

(71) Applicant: CASIO COMPUTER CO., LTD., Tokyo (JP)

(72) Inventor: Hideki TAKAHASHI, Tokyo (JP)

(73) Assignee: CASIO COMPUTER CO., LTD., Tokyo (JP)

(21) Appl. No.: 16/512,422

(22) Filed: Jul. 16, 2019

(30) Foreign Application Priority Data
Jul. 24, 2018 (JP) 2018-138761

(51) Int. Cl. B32B 7/027; B32B 7/12; B32B 27/36; B32B 27/40; B32B 27/30; B32B 7/06

(52) U.S. Cl. CPC B32B 7/027; B32B 7/12; B32B 7/06; B32B 27/40; B32B 27/306; B32B 27/36

(57) ABSTRACT

A thermally expandable sheet includes a base, an intermediate layer provided on a first surface of the base, the intermediate layer including a thermally expandable material, and a thermally expansive layer provided on the intermediate layer. The peeling strength between the intermediate layer and the base is less than the peeling strength between the thermally expansive layer and the intermediate layer, and the intermediate layer and the thermally expansive layer are peelable from the base.

### CROSS-REFERENCE TO RELATED APPLICATION

This application claims the benefit of Japanese Patent Application No. 2018-138761, filed on Jul. 24, 2018, the entire disclosure of which is incorporated by reference herein.

### FIELD

The present disclosure relates generally to a thermally expandable sheet that uses a thermally expansive layer including a thermally expandable material that expands according to the amount of heat absorbed, and to a shaped object.

### BACKGROUND

Thermally expandable sheets are known that include a thermally expansive layer containing a thermally expandable material, which expands according to the amount of heat absorbed, on one surface of a base sheet. By forming a photothermal conversion layer that converts light into heat on the thermally expandable sheet and irradiating the photothermal conversion layer with light, part or all of the thermal expansion layer can be caused to distend. Additionally, methods are known for forming a shaped object, which includes unevennesses, on a thermally expandable sheet by causing the shape of a photothermal conversion layer to change (see, for example, Unexamined Japanese Patent Application Kokai Publication Nos. S64-28660 and 2001-150812).

Unevennesses can be easily formed on such a thermally expandable sheet by causing the shape of the photothermal conversion layer to change.

However, it is difficult to recycle the base on which a thermally expansive layer is formed when disposing of used thermally expandable sheets. Consequently, the entire thermally expandable sheet must be disposed of, which is a problem. This becomes a problem when, for example, disposing of a used prototype that has been manufactured using the thermally expandable sheet.

The present disclosure is made with the view of the above situation, and an objective of the present disclosure is to provide a thermally expandable sheet and a shaped object from the thermally expansive layer can be removed.

### SUMMARY

According to an aspect of the present disclosure a thermally expandable sheet includes a base, an intermediate layer provided on a first surface of the base, and a thermally expansive layer provided on the intermediate layer. The thermally expansive layer includes a thermally expandable material. A peeling strength between the intermediate layer and the base is less than a peeling strength between the thermally expansive layer and the intermediate layer, and the intermediate layer and the thermally expansive layer are peelable from the base.

According to another aspect of the present disclosure, a thermally expandable sheet includes a base and a thermally expansive layer provided on a first surface of the base. The thermally expansive layer includes a thermally expandable material. A breaking strength of the thermally expansive layer is greater than a peeling strength of the thermally expansive layer from the base, and the thermally expansive layer is peelable from the base.

### BRIEF DESCRIPTION OF THE DRAWINGS

A more complete understanding of this application can be obtained when the following detailed description is considered in conjunction with the following drawings, in which:

FIG. 1 is a cross-sectional view illustrating an overview of a thermally expandable sheet according to Embodiment 1;

FIG. 2A is a cross-sectional view illustrating a production method for the thermally expandable sheet according to Embodiment 1;

FIG. 2B is a cross-sectional view illustrating the production method for the thermally expandable sheet according to Embodiment 1;

FIG. 2C is a cross-sectional view illustrating a production method for the thermally expandable sheet according to Embodiment 1;

FIG. 3A is a drawing illustrating a shaped object according to Embodiment 1;

FIG. 3B is a drawing illustrating an intermediate layer and a thermally expansive layer that are peeled from a base, according to Embodiment 1;

FIG. 4A is a drawing illustrating the configuration of a shaping system used in a production method for the shaped object according to Embodiment 1;

FIG. 4B is a drawing illustrating the configuration of the shaping system used in the production method for the shaped object according to Embodiment 1;

FIG. 4C is a drawing illustrating the configuration of the shaping system used in the production method for the shaped object according to Embodiment 1;

FIG. 5 is a flowchart illustrating the production method for the shaped object according to Embodiment 1;

FIG. 6A is a cross-sectional view schematically illustrating the production method for the shaped object according to Embodiment 1;

FIG. 6B is a cross-sectional view schematically illustrating the production method for the shaped object according to Embodiment 1;

FIG. 6C is a cross-sectional view schematically illustrating the production method for the shaped object according to Embodiment 1;

FIG. 7 is a cross-sectional view illustrating an overview of a thermally expandable sheet according to Embodiment 2;

FIG. 8A is a cross-sectional view illustrating a production method for the thermally expandable sheet according to Embodiment 2;

FIG. 8B is a cross-sectional view illustrating the production method for the thermally expandable sheet according to Embodiment 2;

FIG. 9A is a drawing illustrating a shaped object according to Embodiment 2; and

FIG. 9B is a drawing illustrating a thermally expansive layer that is peeled from a base, according to Embodiment 2.

### DETAILED DESCRIPTION

Hereinafter, thermally expandable sheets and shaped objects according to embodiments of the present disclosure are described in detail using the drawings.

In this application, the term “shaped object” refers to a thermally expandable sheet in which shapes such as simple shapes such as convexities (protrusions) and concavities (recesses), geometrical shapes, characters, patterns, and decorations are shaped (formed) on a predetermined surface of the thermally expandable sheet. The term “decorations” refers to objects that appeal to the aesthetic sense through visual and/or tactile sensation. The term “shaped (or molded)” refers to the forming of a shaped object, and should be construed to also include concepts such as decorating and ornamenting. The shaped object of the present embodiment is a three-dimensional object that includes unevennesses, geometrical shapes, decorations, or the like on a predetermined surface. However, to distinguish this three-dimensional object from three-dimensional objects formed using a so-called 3D printer, the shaped object of the present embodiment is called a 2.5-dimensional (2.5D) object or a pseudo-three-dimensional (pseudo-3D) object. Moreover, the technique used to produce the shaped object of the present embodiment is called 2.5D printing or pseudo-3D printing.

In the present description, for ease of description, the side of the thermally expandable sheet where the thermally expansive layer is provided is referred to as the front side (front surface) or the top surface, and the side of the thermally expandable sheet where the base is provided is referred to as the back side (back surface) or the bottom side. The terms “front”, “back”, “top”, and “bottom” should not be construed to limit the method of use of the thermally expandable sheet. That is, depending on the method of use of the molded thermally expandable sheet, the back side of the thermally expandable sheet can be used as the front side. The same is applicable to the shaped object as well.

### EMBODIMENT 1

### Thermally Expandable Sheet 10

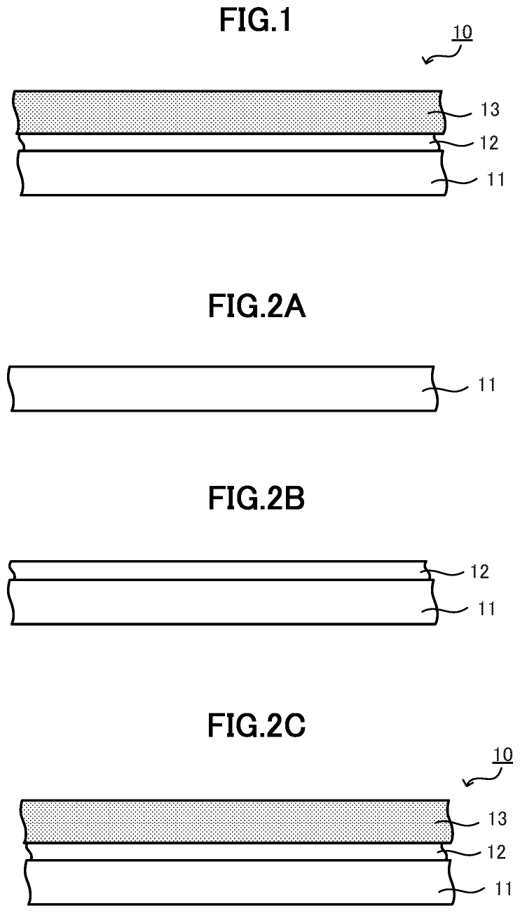

As illustrated in FIG. 1, the thermally expandable sheet 10 includes a base 11, an intermediate layer 12 provided on a first surface (the top surface in FIG. 1) of the base 11, and a thermally expansive layer 13 provided on the intermediate layer 12.

The base 11 is implemented as a sheet-like member that supports the intermediate layer 12 and the thermally expansive layer 13. The intermediate layer 12 is provided on the first surface of the base 11. The base 11 is a sheet that is formed from paper or resin. Any paper, such as high-quality paper, synthetic paper, or the like can be used as the paper. While not limited hereto, polyolefin resins such as polyethylene (PE) and polypropylene (PP), polyethylene terephthalate (PET), polyethylene naphthalate (PEN), polybutylene terephthalate (PBT), polyester resins, polyamide resins such as nylon, polyvinyl chloride (PVC) resins, polystyrene (PS), polyimide resins, and the like can be used as the resin.

The intermediate layer 12 is provided on the first surface of the base 11. The intermediate layer 12 is peelably adhered to the base 11. The thermally expansive layer 13 is provided on the intermediate layer 12. In the present embodiment, the intermediate layer 12 is provided between the base 11 and the thermally expansive layer 13. Accordingly, the peeling strength between the intermediate layer 12 and the base 11 is less than the peeling strength between the intermediate layer 12 and the thermally expansive layer 13. As such, the thermally expansive layer 13 can be peeled and removed from the base 11.

It is preferable that the intermediate layer 12 has peeling strength sufficient such that, at least in normal use, the intermediate layer 12 does not peel from the thermally expandable sheet 10. The phrase “normal use” includes general handling of the thermally expandable sheet 10 by a user, and also includes typically anticipated modes of use of the thermally expandable sheet 10. Examples of the general handling by a user include the user carrying the thermally expandable sheet 10. Examples of the typically anticipated modes of use include printing on the thermally expandable sheet 10 and causing the thermally expansive layer 13 to distend. Furthermore, it is preferable that the intermediate layer 12 have breaking strength sufficient to prevent breakage when peeling the thermally expansive layer 13. One example of such an intermediate layer 12 is a resin film that is provided with an adhesive layer on one surface. In one example, the adhesive layer is a thermosetting adhesive. Among thermosetting adhesives, adhesives that contain vinyl chloride vinyl acetate copolymer resin are preferable. The solvent of the adhesive may be water-based or solvent-based. Additionally, the adhesive layer may be implemented as an adhesive that has slight adhesion such as an acrylic adhesive or a silicone adhesive. The resin film is formed from a resin selected from, for example, polyester, polyethylene, polyvinyl alcohol, and polyethylene terephthalate, or a copolymer thereof. The intermediate layer 12 is peelably adhered to the base 11, in a state in which the surface of the resin film where the adhesive layer is provided faces the base 11. In one example, the resin film that constitutes the intermediate layer 12 is implemented as a resin film that is formed from ethylene-vinyl alcohol copolymer. It is preferable that a thickness of the resin film that constitutes the intermediate layer 12 is from 12 μm to 15 μm. It is preferable that a thickness of the adhesive layer is from 2 μm to 4 μm.

It is preferable that the peeling strength of the adhesive layer is 0.06 N/20 mm or greater. This configuration makes it possible to substantially prevent the intermediate layer 12 from peeling due to generally handling by a user. In order to effectively cause the intermediate layer 12 to peel from the base 11, the peeling strength of the adhesive layer is preferably 0.5 N/20 mm or less and is more preferably 0.4 N/20 mm or less. The peeling strength is measured by a 180° peeling strength test.

The intermediate layer 12 is not limited to a resin film that includes an adhesive layer. It is sufficient that the intermediate layer 12 is configured such that the peeling strength between the intermediate layer 12 and the base 11 is less than the peeling strength between the intermediate layer 12 and the thermally expansive layer 13. For example, the intermediate layer 12 may be formed from a resin selected from a polyvinyl alcohol (PVA) resin, a polyester resin, a polyurethane resin, an acrylic resin, and the like. Examples of such a resin include NS625, manufactured by Takamatsu Oil & Fat Co., Ltd.

The thermally expansive layer 13 is provided on the intermediate layer 12. The thermally expansive layer 13 is a layer that distends a magnitude according to heating conditions (for example, the heating temperature and the heating time). The thermally expansive layer 13 includes a binder and a thermally expandable material (for example, thermally expandable microcapsules, micropowder, or the like) dispersed in the binder. The thermally expansive layer 13 is not limited to one layer and may include a plurality of layers. Any thermoplastic resin, such as, for example, an ethylene-vinyl-acetate polymer or an acrylic polymer, may be used as the binder of the thermally expansive layer 13.

The thermally expandable microcapsules are capsules that contain propane, butane, or a similar low boiling point volatile substance in thermoplastic resin shells. The shells are formed from a thermoplastic resin such as, for example, polystyrene, polyvinyl chloride, polyvinylidene chloride, polyvinyl acetate, polyacrylic acid ester, polyacrylonitrile, polybutadiene, or copolymers thereof. In one example, the average particle size of the thermally expandable microcapsules is about 5 μm to 50 μm. When these microcapsules are heated to an expansion starting temperature or higher, the shells that are made from the resin soften and the low boiling point volatile substance encapsulated therein vaporizes. The pressure produced by the vaporized low boiling point volatile substance causes the shells to expand in a balloon-like manner. In one example, the expanded microcapsules are about five-times larger than the size of the microcapsules prior to expansion. Note that the particle size of the microcapsules varies, and all of the microcapsules do not have the same particle size.

### Production Method for Thermally Expandable Sheet

The thermally expandable sheet 10 of the present embodiment is produced as follows. First, as illustrated in FIG. 2A, a sheet made from PET, for example, is prepared as the base 11. The base 11 may be in a roll shape or may be precut.

Next, the intermediate layer 12 is affixed to the base 11 by a laminating apparatus that includes an input roller, a heater roller, a roller, and an output roller. The intermediate layer 12 is implemented as a resin film that includes the adhesive layer on the surface that faces the base 11. A thermosetting adhesive is used for the adhesive layer. In one example, an adhesive that contains vinyl chloride vinyl acetate copolymer resin is used for the adhesive layer. An adhesive that has slight adhesion such as an acrylic adhesive or a silicone adhesive may be used for the adhesive layer. For example, while in a wound state, the base 11 is set at an unwinding position of the laminating apparatus. The base 11 passes between the pair of input rollers and is transported toward the heater roller and the roller. Meanwhile, the resin film used as the intermediate layer 12 is fed to the heater roller. When the resin film is heated by the heater roller and passes between the heater roller and the roller, pressure is applied and the resin film is peelably adhered to the base 11. After the intermediate layer 12 is adhered, the base 11 is transported between the pair of output rollers and output. Thus, the intermediate layer 12 is affixed on the base 11, as illustrated in FIG. 2B.

Next, the binder made from the thermoplastic resin and the like is mixed with the thermally expandable material (the thermally expandable microcapsules) to prepare a coating liquid for forming the thermally expansive layer 13. Then, using a known coating device such as a bar coater, a roll coater, or a spray coater, the prepared coating liquid is applied on the base 11. As illustrated in FIG. 2C, the coated film is dried and, as a result, the thermally expansive layer 13 is formed. The application and the drying of the coating liquid may be carried out a plurality of times in order to obtain a predetermined thickness of the thermally expansive layer 13. The thermally expansive layer 13 may be formed by using a printing device such as a screen printing device. Moreover, when produced from a roll-shaped base 11, the resulting roll-shaped thermally expandable sheet 10 may be cut. The thermally expandable sheet 10 is produced as described above.

### Shaped Object 20

Next, the drawings are used to describe the shaped object 20. The shaped object 20 is produced by causing the thermally expansive layer 13 of the thermally expandable sheet 10 to distend.

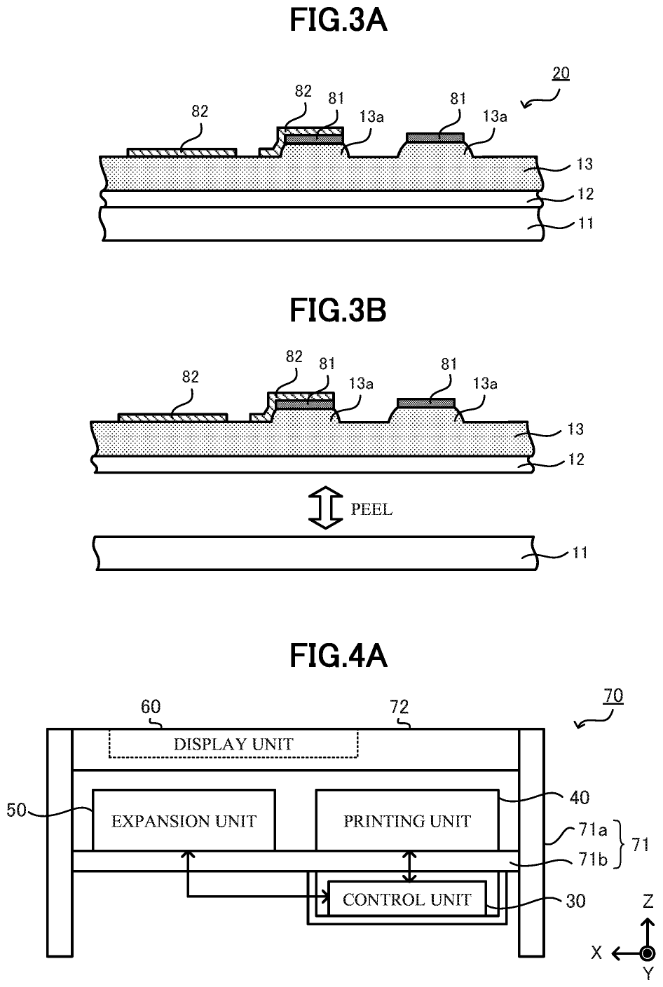

FIG. 3A illustrates the shaped object 20 that is produced by causing the thermally expansive layer 13 to distend. FIG. 3B illustrates the intermediate layer 12 and the thermally expansive layer 13 peeled from the base 11. As illustrated in FIG. 3A, in the shaped object 20, an electromagnetic wave heat conversion layer 81 that converts electromagnetic waves into heat (hereinafter referred to as “heat conversion layer”) is provided on the surface of the front surface (on the thermally expansive layer 13 in FIG. 3A) of the thermally expandable sheet 10. The thermally expansive layer 13 directly under the heat conversion layer 81 is distended and risen. The thermally expansive layer 13 includes a protrusion 13a on the top surface of the shaped object 20. The protrusion 13a is a result of the rising of the thermally expansive layer 13.

While described later, in the present embodiment, the heat conversion layer 81, which includes an electromagnetic wave heat conversion material that converts electromagnetic waves into heat, is formed on the surface of the front side of the thermally expandable sheet 10. Thereafter, the heat conversion layer 81 is irradiated with electromagnetic waves and, as a result, generates heat. Infrared absorbing agents such as cesium tungsten oxide and lanthanum hexaboride, carbon black, and the like can be used as the electromagnetic wave heat conversion material. The heat conversion layer 81 is heated due to being irradiated with electromagnetic waves and, as such, is also called a “heated layer.” The heat generated by the heat conversion layer 81, which is formed on the surface of the front side of the thermally expandable sheet 10, is transmitted to the thermally expansive layer 13. The thermally expandable material in the thermally expansive layer 13 foams due to the heat that is transmitted to the thermally expansive layer 30. As a result, the thermally expansive layer 13 distends. The electromagnetic waves are converted into heat more quickly in regions where the heat conversion layer 81 is provided than in regions where the heat conversion layer 81 is not provided. Accordingly, the regions near the heat conversion layer 81 can be selectively heated, and specific regions of the thermally expansive layer 13 can be selectively caused to distend and rise.

In the shaped object 20 of the present embodiment, the desired shape is expressed by unevennesses formed on the front surface of the thermally expansive layer 13. As such, the surface of the side of the base 11 opposite the side where the thermally expansive layer 13 is provided (the bottom surface of the base 11 illustrated in FIG. 3A) is not deformed. Here, “deformation of the base 11 or the surface of the base 11” includes the unavoidable deformation of the base 11 or the surface of the base 11 due to the distending forces of the thermally expansive layer 13.

When the base 11 is formed from a material that easily deforms when subjected to heat (for example, non-oriented PET), the surface of the side of the base 11 opposite the side where the thermally expansive layer 13 is provided may deform due to the distension of the thermally expansive layer 30. In such a case, a protrusion (not illustrated in the drawings) is formed on the surface of the base 11 where the thermally expansive layer 13 is provided, and a recess (not illustrated in the drawings), which corresponds to the protrusion, is formed in the bottom surface of the base 11.

In the present embodiment, a color ink layer 82 is provided on the surface of the front surface of the shaped object 20. The color ink layer 82 is a layer that is formed from an ink that is used in a desired printing device such as an offset printing device, a flexographic printing device, or the like. The color ink layer 82 may be formed using a water-based ink, an oil-based ink, an ultraviolet curable ink, or the like. The color ink layer 82 expresses a desired image such as characters, numbers, photographs, patterns, or the like. When the color ink layer 82 is formed using a water-based ink jet printer, it is preferable that an ink receiving layer that receives the ink is provided on the back surface of the base 11 and that the color ink layer 82 is formed on this ink receiving layer. Note that, depending on the printing method, the type of ink, and the like, the color ink layer 82 may not form a distinct layer. However, in the present description, for ease of description, the expression “layer” is used to refer to the color ink layer 82. Configurations are possible in which the color ink layer 82 is provided on the back side of the shaped object 20. Additionally, configurations are possible in which the color ink layer 82 is provided on both the front side and the back side of the shaped object 20. Moreover, configurations are possible in which the color ink layer 82 is not provided.

In one example, the shaped object 20 of the present embodiment is used as a prototype and, after use, is discarded. A desired shaped object 20 is produced as a prototype by combining the unevennesses on the front surface of the thermally expansive layer 13, the color ink layer 82, and the like. When discarding the shaped object 20 that has been used as a prototype, as illustrated in FIG. 3B, the intermediate layer 12 can be peeled from the base 11 to remove the intermediate layer 12 and the thermally expansive layer 13 from the base 11. Thus, the base 11, and the intermediate layer 12 and the thermally expansive layer 13 can be disposed of separately. Since the intermediate layer 12 and the thermally expansive layer 13 are removed, the base 11 can be recycled.

### Production Method for Shaped Object

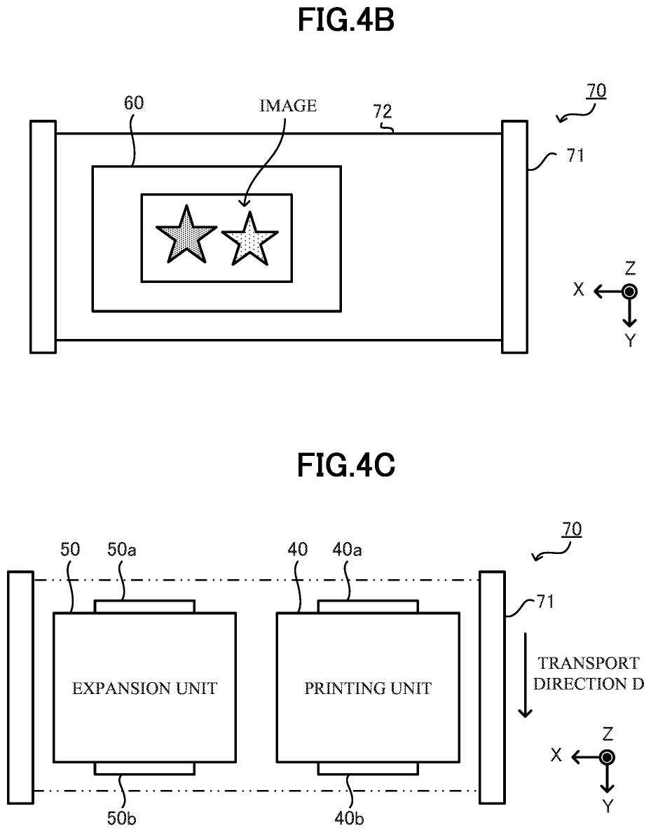

Next, an explanation will be given of the flow of a method in which the thermally expandable sheet 10 is molded and the shaped object 20 is produced, while referencing FIGS. 4A to 4C, FIG. 5, and FIGS. 6A to 6C. In the production method for the shaped object 20, an example is given in which the shaped object 20 is produced from an individual sheet, but a configuration is possible in which the shaped object 20 is produced from a thermally expandable sheet 10 that is wound in a roll-shape.

### Shaping System

Next, while referencing FIGS. 4A to 4C, a description will be given of a shaping system 70 for producing the shaped object 20 from the thermally expandable sheet 10. FIG. 4A is a front view of the shaping system 70. FIG. 4B is a plan view of the shaping system 70 and depicts a state in which a top plate 72 is closed. FIG. 4C is a plan view of the shaping system 70 and depicts a state in which the top plate 72 is open. In FIGS. 4A to 4C, the X-direction corresponds to the direction in which a printing unit 40 and an expansion unit 50 are juxtaposed. The Y-direction corresponds to the transport direction of the thermally expandable sheet 10 in the printing unit 40 and the expansion unit 50. The Z-direction corresponds to the vertical direction. The X-direction, the Y-direction, and the Z-direction are orthogonal to each other.

The shaping system 70 includes a control unit 30, a printing unit 40, an expansion unit 50, and a display unit 60. The control unit 30, the printing unit 40, and the expansion unit 50 are arranged in the frame 71 as illustrated in FIG. 4A. The frame 71 includes a pair of substantially rectangular sideboards 71a and a coupling beam 71b provided between the sideboards 71a. The frame 71 also includes a top plate 72 that spans between upper portions of the sideboards 71a. The printing unit 40 and the expansion unit 50 are installed juxtaposed in the X-direction on the coupling beam 72b that spans between the sideboards 71a. The control unit 30 is fixed below the coupling beam 71b. The display unit 60 is embedded in the top plate 72 so as to be flush with the top surface of the top plate 72.

### Control Unit

The control unit 30 controls the printing unit 40, the expansion unit 50, and the display unit 60. The control unit 30 supplies power to the printing unit 40, the expansion unit 50, and the display unit 60. The control unit 30 includes a controller that includes a central processing unit (CPU) or the like, a storage unit that includes flash memory, a hard disk, or the like, a communicator that is an interface for communicating with external devices, and a non-transitory recording medium driver that reads out programs and data stored on a portable non-transitory recording medium (all not illustrated in the drawings). Each of these components is connected to a bus for transmitting signals. The non-transitory recording medium driver acquires, from the portable non-transitory recording medium, front surface foaming data that represents an image to be printed by the printing unit 40. The front surface foaming data is data that indicates the portion of the front surface of the thermally expandable sheet 10 where the thermally expandable material is to be foamed and the thermally expansive layer 13 is to be caused to distend.

### Printing Unit

The printing unit 40 acquires image data from the control unit 30. The printing unit 40 prints, on the basis of the acquired data, the heat conversion layer 81, color images, and the like on the front surface and/or the back surface of the thermally expandable sheet 10. In the present embodiment, the printing unit 40 is an ink jet printer that prints images via a method in which ink is micronized and directly sprayed on print media. Any desired ink can be used in the printing unit 40. For example, a water-based ink, a solvent-based ink, an ultraviolet-curable ink, or the like can be used in the printing unit 40. Note that the printing unit 40 is not limited to an ink jet printer.

Ink that contains an electromagnetic wave heat conversion material (heat conversion ink) is stored in the ink cartridges of the printing unit 40. The electromagnetic wave heat conversion material (heat conversion material) is a material that is capable of converting electromagnetic waves into heat. On example of the heat conversion material is carbon black (graphite). Carbon black absorbs electromagnetic waves and thermally vibrates, thereby generating heat. Note that the heat conversion material is not limited to carbon black and, for example, cesium tungsten oxide, lanthanum hexaboride, and other infrared absorbing materials may be used.

As illustrated in FIG. 4C, the printing unit 40 includes a loader 40a for loading the thermally expandable sheet 10, and a discharger 40b for discharging the thermally expandable sheet 10. The printing unit 40 prints an image on the front surface and/or the back surface of the thermally expandable sheet 10 loaded through the loader 40a. The printing unit 40 discharges the thermally expandable sheet 10 on which the image has been printed through the discharger 40b.

### Expansion Unit

The expansion unit 50 irradiates the front surface and/or the back surface of the thermally expandable sheet 10 with electromagnetic waves, thereby causing at least a portion of the thermally expansive layer 13 to distend. The expansion unit 50 includes a lamp heater, a reflection plate that reflects the electromagnetic waves emitted from the lamp heater toward the thermally expandable sheet 10, a temperature sensor that measures the temperature of the reflection plate, and a cooler that cools the interior of the expansion unit 50 (all not illustrated in the drawings). The expansion unit 50 further includes a pair of transport rollers that sandwiches and transports the thermally expandable sheet 10 along a transport guide, and a transport motor for rotating the pair of transport rollers (all not illustrated in the drawings).

In one example, the lamp heater includes a halogen lamp. The lamp heater irradiates the thermally expandable sheet 10 with electromagnetic waves (light) in the near-infrared region (750 to 1400 nm wavelength range), the visible light spectrum (380 to 750 nm wavelength range), or the intermediate infrared region (1400 to 4000 nm wavelength range). When the thermally expandable sheet 10, on which a gray-scale image formed from the heat conversion ink (heat generating ink) that contains the heat conversion material is printed, is irradiated with the electromagnetic waves, the portions where the gray-scale image is printed convert the electromagnetic waves into heat more efficiently than the portions where the gray-scale image is not printed. As a result, the portions of the thermally expandable sheet 10 where the gray-scale image is printed are heated and, when the temperature of the thermally expandable material of the portion where the gray-scale image is printed reaches the temperature at which expansion begins (expansion starting temperature), the thermally expandable material of the portions where the gray-scale image is printed expands. Note that the lamp heater is not limited to a halogen lamp, and any component that emits electromagnetic waves may be used. Moreover, the wavelengths of the electromagnetic waves are not limited to the ranges described above.

The expansion unit 50 irradiates the front surface and/or the back surface of the thermally expandable sheet 10 with electromagnetic waves, thereby causing at least a portion of the thermally expansive layer 13 to distend. As illustrated in FIG. 4C, the expansion unit 50 includes a loader 50a for loading the thermally expandable sheet 10, and a discharger 50b for discharging the thermally expandable sheet 10. The expansion unit 50 irradiates the front surface and/or the back surface of the thermally expandable sheet 10, loaded through the loader 50a, with electromagnetic waves, thereby causing at least a portion of the thermally expansive layer 13 to distend. Then, the expansion unit 50 discharges the thermally expandable sheet 10 in which the thermally expansive layer 13 has been distended through the discharger 50b.

### Display Unit

The display unit 60 includes a display device such as a liquid crystal display or an organic electro luminescence (EL) display and a display driving circuit that causes images to be displayed on the display device. As illustrated in FIG. 4B, the display unit 60 displays an image (for example, the stars illustrated in FIG. 4B) printed on the thermally expandable sheet 10 by the printing unit 40. Additionally, the display unit 60 may display information indicating the state of the printing unit 40 and/or the state of the expansion unit 50. The shaping system 70 may include an operation unit, such as buttons or switches, that is operated by a user. The display unit 60 may include a touch panel or a touch screen.

In the shaping system 70 of the present embodiment, the amount of expansion of the thermally expandable material is controlled by the density of the gray-scale image (the image based on the front surface foaming data or the back surface foaming data), control of the electromagnetic waves, and the like. Additionally, the height to which the thermally expansive layer 13 rises can be controlled, and the desired protrusions or uneven shapes can be formed on the surface of the thermally expandable sheet 10 by controlling the amount of expansion of the thermally expandable material. Here, the phrase “controlling the electromagnetic waves” means controlling the amount of energy that the thermally expandable sheet 10 receives per unit area when the thermally expandable sheet 10 is irradiated with the electromagnetic waves. Specifically, the amount of energy that the thermally expandable sheet 10 receives per unit area changes depending on parameters such as the irradiation intensity, the movement speed, the irradiation time, and the irradiation distance of the lamp heater, temperature, humidity, and cooling. The controlling of the electromagnetic waves is performed by controlling one or more of these parameters.

### Production Method for Shaped Object

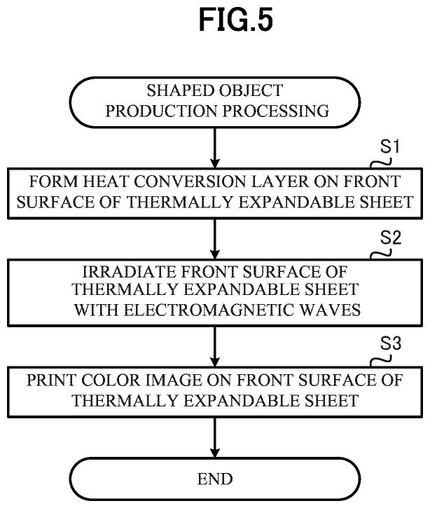

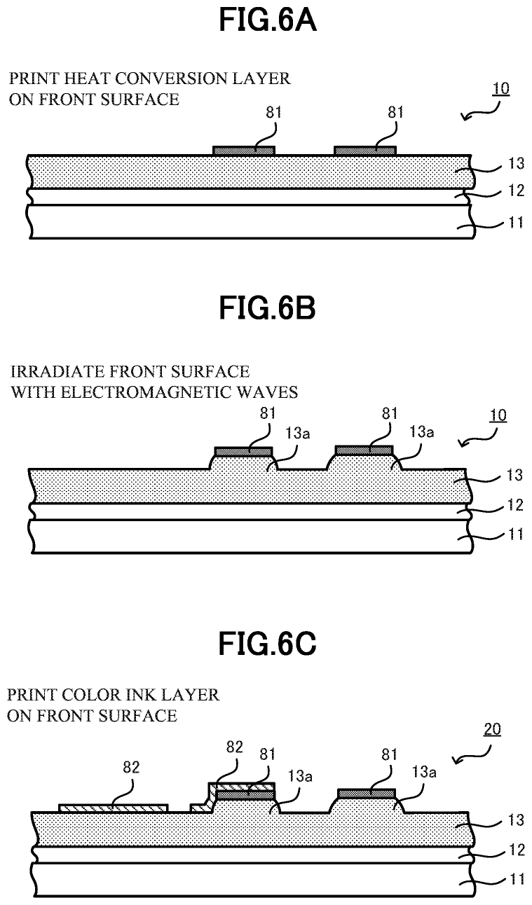

Next, an explanation will be given of the flow of processing for causing at least a portion of the thermally expandable sheet 10 to distend and obtaining the shaped object 20, while referencing FIG. 5 and FIGS. 6A to 6C. FIG. 5 is a flowchart illustrating the production method for the shaped object 20. FIGS. 6A to 6C are cross-sectional views schematically illustrating the production method for the shaped object 20.

First, the thermally expandable sheet 10 is prepared. Foaming data, color image data, and the like are prepared in advance. The foaming data is data for forming the heat conversion layer 81 and is data that indicates the portion of the thermally expandable material where the thermally expandable material is to be foamed and the thermally expansive layer 13 is to be caused to distend. The color image data is image data for forming the color ink layer 82. The thermally expandable sheet 10 is transported to the printing unit 40 with the front surface of the thermally expandable sheet 10 facing upward. The printing unit 40 prints the heat conversion layer 81 on the front surface of the thermally expandable sheet 10 (step S1). The heat conversion layer 81 is formed from an ink that contains the electromagnetic wave heat conversion material. For example, the heat conversion layer 81 is formed from carbon black-containing foamable ink. The printing unit 40 prints, on the basis of the designated foaming data, the heat conversion material-containing foamable ink onto the front surface of the thermally expandable sheet 10. As a result, the heat conversion layer 81 is formed on the front surface of the thermally expandable sheet 10, as illustrated in FIG. 6A. Note that, when the heat conversion layer 81 is printed with greater density, the amount of generated heat of the heat conversion layer 81 increases and, as a result, the thermally expansive layer 13 rises higher. Moreover, when the base 11 is to be deformed, the amount of deformation of the base 11 increases when the heat conversion layer 81 is printed with greater density. When the base 11 is to be deformed, the deformation height of the base 11 can be controlled by controlling the density of the heat conversion layer 81.

Second, the thermally expandable sheet 10 on which the heat conversion layer 81 is printed is transported to the expansion unit 50 with the front surface of the thermally expandable sheet 10 facing upward. The expansion unit 50 irradiates the transported thermally expandable sheet 10 with electromagnetic waves (step S2). Specifically, the lamp heater of the expansion unit 50 irradiates the front surface of the thermally expandable sheet 10 with electromagnetic waves. The heat conversion material, included in the heat conversion layer 81 printed on the front surface of the thermally expandable sheet 10, absorbs the irradiated electromagnetic waves, thereby generating heat. The heat generated in the heat conversion layer 81 is transmitted to the thermally expansive layer 13. The thermally expandable material foams due to the transmitted heat, and the thermally expansive layer 13 distends. As a result, as illustrated in FIG. 6B, the region of the thermally expansive layer 13 of the thermally expandable sheet 10 where the heat conversion layer 81 is printed distends and rises.

Third, the distended thermally expandable sheet 10 is transported to the printing unit 40 with the front surface of the thermally expandable sheet 10 facing upward. The printing unit 40 prints a color image (the color ink layer 82) on the front surface of the thermally expandable sheet 10 (step S3). Specifically, the printing unit 40 discharges the various cyan

(C), magenta (M), and yellow (Y) inks onto the front face of the thermally expandable sheet 10 on the basis of the designated color image data. As a result, the color ink layer 82 is formed on the thermally expansive layer 13, as illustrated in FIG. 6C. The thermally expansive layer 13 of the thermally expandable sheet 10 distends and the shaped object 20 is produced as a result of carrying out the procedures described above.

In the steps described above, the heat conversion layer 81 is formed on the front side of the thermally expandable sheet 10. However, a configuration is possible in which the heat conversion layer 81 is formed on the back side of the thermally expandable sheet 10. Additionally, a configuration is possible in which the heat conversion layer 81 is formed on the front side and the back side of the thermally expandable sheet 10. When the heat conversion layer 81 is formed on the front side and the back side of the thermally expandable sheet 10, the step of causing the thermally expansive layer 13 to distend (step S2) may be performed both after the heat conversion layer 81 is formed on the front side of the thermally expandable sheet 10 and after the heat conversion layer 81 is formed on the back side of the thermally expandable sheet 10. Additionally, a configuration is possible in which the thermally expansive layer 13 is caused to distend by performing the step of causing the thermally expansive layer 13 to distend one time, after the heat conversion layer 81 has been formed on the front side and the back side of the thermally expandable sheet 10. Note that, in step S2 described above, the surface on which the heat conversion layer 81 is formed is irradiated with the electromagnetic waves, but a configuration is possible in which, in step S2, the surface of the side opposite the side on which the heat conversion layer 81 is formed is irradiated with the electromagnetic waves, and the thermally expansive layer 13 is caused to distend.

After the shaped object 20 is used, the thermally expansive layer 13 of the shaped object 20 is peeled from the base 11. Specifically, first, an end of the intermediate layer 12 is peeled from an end of the base 11. Then, the end of the intermediate layer 12 that is peeled and the thermally expansive layer 13 that is provided on the intermediate layer 12 are pulled, and the intermediate layer 12 and the thermally expansive layer 13 are peeled from the base 11. As a result, the intermediate layer 12 and the thermally expansive layer 13 are removed from the base 11, as illustrated in FIG. 3B. Thus, the base 11, the intermediate layer 12, and the thermally expansive layer 13 can be disposed of separately. Moreover, the base 11 can be recycled. The peeling of the intermediate layer 12 and the thermally expansive layer 13 may be performed manually, or by a machine.

### EMBODIMENT 2

### Thermally Expandable Sheet 15

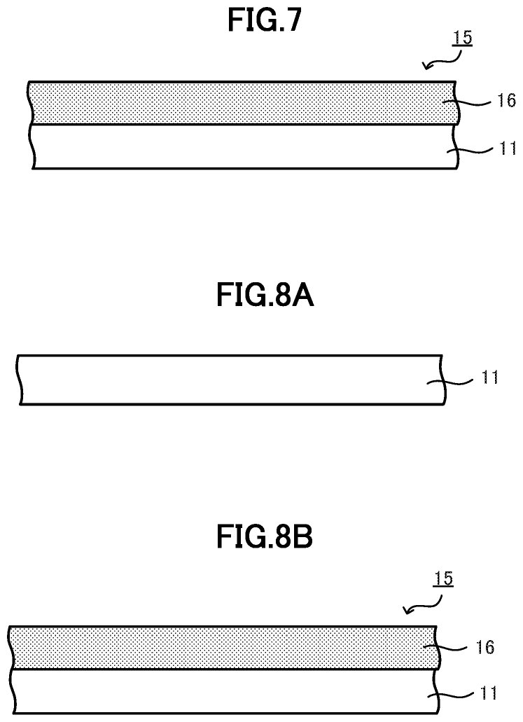

As illustrated in FIG. 7 a thermally expandable sheet 15 includes a base 11 and a thermally expansive layer 16 provided on a first surface (the top surface illustrated in FIG. 7) of the base 11. The thermally expandable sheet 15 of the present embodiment does not include an intermediate layer 12. Furthermore, in the thermally expandable sheet 15, a thermally expansive layer 16 is provided directly on the base 11. The other configurations of the thermally expandable sheet 15 are the same as the configurations of the thermally expandable sheet 10 of Embodiment 1. Detailed descriptions of constituents that are the same as those described in Embodiment 1 are forgone.

The base 11 is the same as the base 11 of Embodiment 1. The base 11 is implemented as a sheet-like member that supports the thermally expansive layer 16. In the present embodiment, the thermally expansive layer 16 is provided on the first surface of the base 11.

The thermally expansive layer 16 is provided on the first surface of the base 11. As with the thermally expansive layer 13 of Embodiment 1, the thermally expansive layer 16 is a layer that distends a magnitude according to the heating conditions. The thermally expansive layer 16 includes a binder and a thermally expandable material dispersed in the binder. In the present embodiment, the thermally expansive layer 16 is removed from the base 11 by peeling the thermally expansive layer 16 from the base 11 after the shaped object 21 (described later) is used. It is preferable that the thermally expansive layer 16 includes a binder made from a thermoplastic elastomer so that the thermally expansive layer 16 will be less likely to break when peeling. The thermoplastic elastomer of the binder is selected from polyvinyl chloride, ethylene propylene rubber (EPR), ethylene-vinyl acetate copolymer (EVA), styrene thermoplastic elastomers, olefin thermoplastic elastomers, urethane thermoplastic elastomers, polyester thermoplastic elastomers, or the like. It is particularly preferable that the binder is a styrene elastomer.

In the present embodiment, it is preferable that the thermally expansive layer 16 does not break when peeling. Additionally, if the thermally expansive layer 16 peels from the base 11 when the thermally expansive layer is distended, it is difficult to form a desired unevenness on the front surface of the thermally expansive layer 16. Therefore, it is preferable that the adhesive strength between the thermally expansive layer 16 and the base 11 is at least such that the thermally expansive layer 16 does not peel from the base 11 when the thermally expansive layer 16 distends. Furthermore, it is preferable that the breaking strength of the thermally expansive layer 16 is greater than the peeling strength between the thermally expansive layer 16 and the base 11. It is more preferable that breaking strength of the thermally expansive layer 16 is at least two-times greater than the peeling strength between the thermally expansive layer 16 and the base 11.

### Production Method of Thermally Expandable Sheet

The thermally expandable sheet 15 of the present embodiment is produced as follows. First, as illustrated in FIG. 8A, a sheet made from PET, for example, is prepared as the base 11. The base 11 may be in a roll shape or may be precut.

Next, the binder made from the thermoplastic resin and the like is mixed with the thermally expandable material (the thermally expandable microcapsules) to prepare a coating liquid for forming the thermally expansive layer 16. In the present embodiment, it is preferable that the binder contains a thermoplastic elastomer. The thermoplastic elastomer is selected from polyvinyl chloride, ethylene propylene rubber (EPR), ethylene-vinyl acetate copolymer (EVA), styrene thermoplastic elastomers, olefin thermoplastic elastomers, urethane thermoplastic elastomers, polyester thermoplastic elastomers, or the like. However, the thermoplastic elastomer is not limited thereto.

In the present embodiment, it is preferable that the adhesive strength between the thermally expansive layer 16 and the base 11 is at least such that the thermally expansive layer 16 does not peel from the base 11 when the thermally expansive layer 16 distends. Furthermore, the breaking strength of the thermally expansive layer 16 is greater than the adhesive strength between the thermally expansive layer 16 and the base 11 and, preferable is at least two-times greater than the adhesive strength between the thermally expansive layer 16 and the base 11. The material constituting the binder included in the thermally expansive layer 16, the mixing ratio of the binder in the coating liquid, and the like are determined such that these conditions are satisfied. Moreover, it is particularly preferable that the binder is a styrene elastomer.

Then, using a known coating device, the prepared coating liquid is applied on the base 11. As illustrated in FIG. 8B, the coated film is dried, thereby forming the thermally expansive layer 16. The application and the drying of the coating liquid may be carried out a plurality of times in order to obtain a predetermined thickness of the thermally expansive layer 16. The thermally expansive layer 16 may be formed by using a printing device. Moreover, the roll-shaped thermally expandable sheet 15 that is produced from the roll-shaped base 11 may be cut. The thermally expandable sheet 15 is produced as described above.

### Shaped Object 21

Next, the drawings are used to describe a shaped object 21. The shaped object 21 is produced by causing the thermally expansive layer 16 of the thermally expandable sheet 15 to distend.

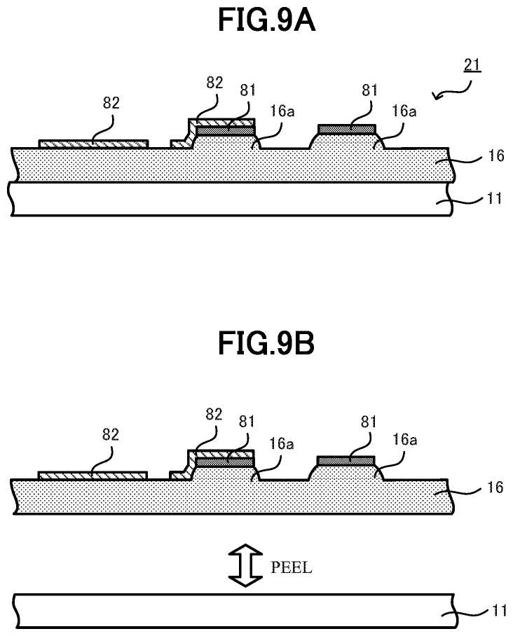

FIG. 9A illustrates the shaped object 21 that is produced by causing the thermally expansive layer 16 to distend. FIG. 9B illustrates the thermally expansive layer 16, peeled from the base 11. As illustrated in FIG. 9A, in the shaped object 21, an electromagnetic wave heat conversion layer 81 that converts electromagnetic waves into heat (heat conversion layer) is provided on the surface of the front side (on the thermally expansive layer 16 in FIG. 9A) of the thermally expandable sheet 15. The thermally expansive layer 16 directly under the heat conversion layer 81 is distended and risen. The thermally expansive layer 16 includes a protrusion 16a on the top surface of the shaped object 21. The protrusion 16a is a result of the rising.

As with the shaped object 20 of Embodiment 1, in the shaped object 21 of the present embodiment the back surface of the base 11 is not deformed. When the base 11 is formed from a material that easily deforms when subjected to heat, the back surface of the base 11 may deform due to the distension of the thermally expansive layer 16. Moreover, as with the shaped object 20 of Embodiment 1, a color ink layer 82 is provided on the surface of the front side of the shaped object 21. The color ink layer 82 is a layer that is formed from an ink that is used in a desired printing device. The color ink layer 82 may be formed from a water-based ink, an oil-based ink, an ultraviolet curable ink, or the like. Configurations are possible in which the color ink layer 82 is provided on the back side of the shaped object 21. Additionally, configurations are possible in which the color ink layer 82 is provided on both the front side and the back side of the shaped object 21. Moreover, configurations are possible in which the color ink layer 82 is not provided on the shaped object 21.

When discarding the shaped object 21 of the present embodiment, as illustrated in FIG. 9B, the thermally expansive layer 16 can be peeled from the base 11 to remove the thermally expansive layer 16 from the base 11. Due to this configuration, a state can be achieved in which the thermally expansive layer 16 is not present on the base 11 and, as such, the base 11 can be recycled.

In the present embodiment, the shaped object 21 is produced by the same procedures described in Embodiment 1. Specifically, as illustrated in the flowchart of in FIG. 5, the thermally expandable sheet 15 is transported to the printing unit 40 with the front surface of the thermally expandable sheet 15 facing upward, and the heat conversion layer 81 is printed on the front surface of the thermally expandable sheet 15 (step S1). Second, in the expansion unit 50, the thermally expandable sheet 15, on which the heat conversion layer 81 is printed, is irradiated with electromagnetic waves (step S2), thereby causing at least a portion of the thermally expansive layer 16 to distend. Third, the distended thermally expandable sheet 10 is transported to the printing unit 40 with the front surface of the thermally expandable sheet 10 facing upward, and a color image (color ink layer 82) is printed on the front surface of the thermally expandable sheet 15 (step S3).

Note that a configuration is possible in which, as in Embodiment 1, the heat conversion layer 81 is formed on the back side of the thermally expandable sheet 15. Additionally, a configuration is possible in which the heat conversion layer 81 is formed on the front side and the back side of the thermally expandable sheet 15. In such a case, the step of causing the thermally expansive layer 16 to distend (step S2) may be performed both after the heat conversion layer 81 is formed on the front side of the thermally expandable sheet 15 and after the heat conversion layer 81 is formed on the back side of the thermally expandable sheet 15. Additionally, a configuration is possible in which the thermally expansive layer 16 is caused to distend by performing the step of causing the thermally expansive layer 16 to distend one time, after the heat conversion layer 81 has been formed on the front side and the back side of the thermally expandable sheet 15. Note that, in step S2 described above, the surface on which the heat conversion layer 81 is formed is irradiated with the electromagnetic waves, but a configuration is possible in which, in step S2, the surface of the side opposite the side on which the heat conversion layer 81 is formed is irradiated with the electromagnetic waves, and the thermally expansive layer 16 is caused to distend.

As illustrated in FIG. 9B, after the shaped object 21 is used, the thermally expansive layer 16 of the shaped object 21 is peeled from the base 11. As a result, the thermally expansive layer 16 is removed from the base 11. Thus, the base 11 can be recycled. The peeling of the thermally expansive layer 16 may be performed manually, or by a machine.

The present disclosure is not limited to the embodiments described above and various modifications and uses are possible.

In the embodiments described above, an example is given in which the use method of the thermally expandable sheet 10 is a prototype production. However, the use method of the thermally expandable sheet 10 is not limited to prototype production. The use method of the thermally expandable sheet 10 can be changed as desired.

In the embodiments described above, the heat conversion layer 81 is formed and, thereafter, is irradiated with the electromagnetic waves to cause the thermally expansive layer 13 or 16 to distend, and then the color ink layer 82 is formed. The order of these steps can be changed as desired. For example, the heat conversion layer 81 and the color ink layer 82 may be formed and, thereafter, irradiated with the electromagnetic waves to cause the thermally expansive layer 13 or 16 to distend. Furthermore, the color ink layer 82 may be formed and, thereafter, the heat conversion layer 81 may be formed and irradiated with the electromagnetic waves.

In the embodiments described above, the control unit 30, the printing unit 40, the expansion unit 50, and the display unit 60 of the shaping system 70 are arranged in the frame 71. However, these units may be arranged separately. Additionally, the printing unit 40 is not limited to an ink jet printer, and may be implemented as any printing device, such as an offset printing device, a flexographic printing device, a gravure printing device, or the like.

The drawings used in the various embodiments are provided for the purpose of explaining the various embodiments. Accordingly, the thicknesses of the various layers of the thermally expandable sheets 10 and 15 should not be construed as being limited to the ratios illustrated in the drawings. In the drawings used in the various embodiments, the heat conversion layer 81 and the like that are provided on the front surface and/or the back surface of the thermally expandable sheet 10 or 15 are highlighted for the sake of description. Accordingly, the thicknesses of the heat conversion layer 81 and the like should not be construed as being limited to the ratios illustrated in the drawings.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A thermally expandable sheet comprising:
a base;
an intermediate layer provided on a first surface of the base; and
a thermally expansive layer provided on the intermediate layer, the thermally expansive layer including a thermally expandable material, wherein
a peeling strength between the intermediate layer and the base is less than a peeling strength between the thermally expansive layer and the intermediate layer, and
the intermediate layer and the thermally expansive layer are peelable from the base.

2. The thermally expandable sheet according to claim 1, wherein
the intermediate layer is a resin film that includes an adhesive layer on a surface that faces the base, and
the intermediate layer is peelably adhered to the base by the adhesive layer.

3. The thermally expandable sheet according to claim 2, wherein a peeling strength of the adhesive layer is from 0.06 N/20 mm to 0.5 N/20 mm.

4. The thermally expandable sheet according to claim 2, wherein
a thickness of the resin film is from 12 μm to 15 μm, and
a thickness of the adhesive layer is from 2 μm to 4 μm.

5. The thermally expandable sheet according to claim 2, wherein the adhesive layer is a thermosetting adhesive that includes vinyl chloride vinyl acetate copolymer resin.

6. The thermally expandable sheet according to claim 1, wherein the intermediate layer includes at least one selected from the group consisting of a polyvinyl alcohol resin, a polyester resin, a polyurethane resin, and an acrylic resin.

7. A shaped object comprising:
the thermally expandable sheet according to claim 1; and
a heat conversion layer provided on one or both of a first surface and a second surface of the thermally expandable sheet, the heat conversion layer including a heat conversion material that converts electromagnetic waves into heat; wherein
the thermally expansive layer in a proximity of a region in which the heat conversion layer is provided is distended.

8. A thermally expandable sheet comprising:
a base; and
a thermally expansive layer provided on a first surface of the base, the thermally expansive layer including a thermally expandable material, wherein
a breaking strength of the thermally expansive layer is greater than a peeling strength of the thermally expansive layer from the base, and
the thermally expansive layer is peelable from the base.

9. The thermally expandable sheet according to claim 8, wherein the breaking strength of the thermally expansive layer is at least two-times the peeling strength of the thermally expansive layer from the base.

10. The thermally expandable sheet according to claim 8, wherein the thermally expansive layer includes a binder that includes a thermoplastic elastomer.

11. A shaped object comprising:
the thermally expandable sheet according to claim 8; and
a heat conversion layer provided on one or both of a first surface and a second surface of the thermally expandable sheet, the heat conversion layer including a heat conversion material that converts electromagnetic waves into heat; wherein
the thermally expansive layer in a proximity of a region in which the heat conversion layer is provided is distended.
